(19) United States
(12) Patent Application Publication
(10) Pub. No.: US 2026/0253336 A1
(43) Pub. Date: Aug. 27, 2026

(54) GENERATING MESH MODELS OF BUILDING FACADES BACKGROUND

(71) Applicant: Signetron Inc., Berkeley, CA (US)

(72) Inventors: Avideh Zakhor, Berkeley, CA (US); Zachary Van Hyfte, SAN DIEGO, CA (US)

(21) Appl. No.: 19/062,983

(22) Filed: Feb. 25, 2025

(51) Int. Cl. G06T 17/20

(52) U.S. Cl. CPC G06T 17/205

(57) ABSTRACT

Methods for generating a mesh model of a building façade are presented including: receiving a number of building inputs; cleaning a number of facade slices corresponding with the building inputs; and generating the mesh model of the building facade. In some embodiments, the receiving the number of building inputs includes: receiving a wireframe building model, the wireframe building model including a number of facade edges and a number of window and door outlines; receiving the number of facade slices corresponding with a building point cloud; and receiving a number of facade planes corresponding with and fit to the number of facade slices.

### BACKGROUND

Recladding projects, which involve completely covering the exterior of a building with insulation panels to improve its energy efficiency, require extremely precise measurements of a building's facades. A high-precision wireframe model provides the overall dimensions of each of the building's facades, but when panels are being mounted directly on a facade, it's also useful to be able to take measurements of specific parts of the facade surface and visualize the surface's subtle curvature and unevenness.

As such, methods for generating mesh models of building facades are presented herein.

### SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented below.

As such, methods for generating a mesh model of a building façade are presented including: receiving a number of building inputs; cleaning a number of facade slices corresponding with the building inputs; and generating the mesh model of the building facade. In some embodiments, the receiving the number of building inputs includes: receiving a wireframe building model, the wireframe building model including a number of facade edges and a number of window and door outlines; receiving the number of facade slices corresponding with a building point cloud; and receiving a number of facade planes corresponding with and fit to the number of facade slices. In some embodiments, the cleaning the number of facade slices includes: selecting a facade-edge pair (F, E) having a shared facade edge, where the facade-edge pair includes a selected facade slice (F) and a neighboring facade slice (F_{adj}); fitting a first set of continuous small square planes to a first area of the selected facade slice proximate with the facade-edge pair, where the first set of continuous small square planes are each fit to a first number of points of the building point cloud; fitting a second set of continuous small square planes to a second area of the neighboring facade slice proximate with the facade-edge pair, where the second set of continuous small square planes each are each fit to a second number of points of the building point cloud; examining each point of the selected facade slice; and if the examining determines that the point is within a selected distance from the facade edge, finding the small square plane from the selected facade slice that is closest to the point; finding the small square plane from the neighboring facade slice that is closest to the point; and if the point is closer to the small square plane of the neighboring facade slice, removing the point from the selected facade slice. In some embodiments, methods further include: if the examining determines that the point is not within the selected distance, leaving the point in the selected facade slice. In some embodiments, methods further include: if the point is closer to the small square plane of the selected facade slice, leaving the point in the selected facade slice. In some embodiments, the generating the mesh model of the building facade includes: finding a number of recessed area outlines; transforming the selected facade slice, the number of facade edges associated with the selected facade slice, and the number of window and door outlines associated with the selected facade slice onto an X-Y plane; generating a set of 2D vertices from the selected facade slice and the number of facade edges; creating a 2D mesh representation of the selected facade slice; and creating a 3D mesh model of the selected facade slice. In some embodiments, finding the number of recessed area outlines includes: finding a number of eligible edges from other facades that lie on the number of facade planes; and assembling the number of recessed area outlines from the number of eligible edges. In some embodiments, the transforming the selected facade includes: finding a transformation (T) that will shift and rotate a selected facade plane onto the X-Y plane; applying (T) to the selected facade slice corresponding with the selected facade plane; applying (T) to the number of facade edges corresponding with the selected facade plane; and applying (T) to the number of window and door outlines corresponding with the selected facade plane. In some embodiments, the generating the set of 2D vertices from the selected facade slice and the corresponding number of facade edges includes: creating a first number of 2D constrained Delaunay triangulation (CDT) vertices along one of the number of facade edges; creating a second number of 2D CDT vertices along a number of window outlines and a number of door outlines; and creating a third number of 2D CDT vertices for a number of grid cell center points. In some embodiments, the creating the first number of 2D CDT vertices along one of the number of facade edges includes: selecting the one of the number of facade edges; introducing 3D vertices along the selected facade edge where a separation distance between existing 3D vertices is greater than a selected separation distance; creating the first number of 2D CDT vertices corresponding with each 3D vertex along the selected facade edge; adding each of the first number of 2D CDT vertices to the set of 2D CDT vertices; and adding a number of CDT edges connecting the first number of 2D CDT vertices. In some embodiments, creating the second number of 2D CDT vertices along the number of window outlines and the number of door outlines includes: selecting the one of the number of window outlines or the number of door outlines; introducing 3D vertices along the number of window outlines or the number of door outlines where the separation distance between existing 3D vertices is greater than a selected separation distance; creating the second number of 2D CDT vertices corresponding with each 3D vertex along the selected window outline or the selected door outline; adding each of the second number of 2D CDT vertices to the set of 2D CDT vertices; and adding a number of CDT edges connecting the second number of 2D CDT vertices. In some embodiments, the creating the third number of 2D CDT vertices for the number of grid cell center points includes: overlaying a 2D grid of contiguous square cells on the selected facade slice; determining to which cell of 2D grid of contiguous square cells each point in the selected facade slice belongs; finding the grid cell center point for each cell of the 2D grid of contiguous square cells; creating a 2D CDT vertex for each grid cell center point where a distance from any of the number of facade edges, the number of window outlines, or the number of door outlines is greater than a selected distance; and adding the 2D CDT vertices corresponding with the number of grid cell center points to the set of 2D CDT vertices. In some embodiments, the creating the 3D mesh model of the selected facade slice includes: computing a Z-coordinate for each 2D CDT vertex in the set of 2D CDT vertices to create a number of 3D vertices; assigning a color to each 3D vertex of the number of 3D vertices; and reverse transforming the number of 3D vertices back to a number of true positions corresponding with the building facade. In some embodiments, the assigning a color to each 3D vertex of the number of 3D vertices includes: assigning the color to each 3D vertex corresponding with an average color of all facade slice points within a selected area.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes and may not have been selected to delineate or circumscribe the inventive subject matter.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is an illustrative flowchart of methods for generating mesh models of building facades in accordance with embodiments of the present invention;

FIG. 2 is an illustrative flowchart of methods for receiving building inputs in accordance with embodiments of the present invention;

FIG. 3 is an illustrative flowchart of methods for cleaning areas of facade slices near facade edges in accordance with embodiments of the present invention;

FIG. 4 is an illustrative flowchart of methods for cleaning areas of facade slices near facade edges in accordance with embodiments of the present invention;

FIG. 5 is an illustrative flowchart of methods for generating mesh models of building facades in accordance with embodiments of the present invention;

FIG. 6 is an illustrative flowchart of methods for finding recessed area outlines in accordance with embodiments of the present invention;

FIG. 7 is an illustrative flowchart of methods for transforming facades onto the X-Y plane in accordance with embodiments of the present invention;

FIG. 8 is an illustrative flowchart of methods for creating 2D CDT vertices for facade edges in accordance with embodiments of the present invention;

FIG. 9 is an illustrative flowchart of methods for creating 2D CDT vertices for recessed area outlines in accordance with embodiments of the present invention;

FIG. 10 is an illustrative flowchart of methods for creating 2D CDT vertices for window/door outlines in accordance with embodiments of the present invention;

FIG. 11 is an illustrative flowchart of methods for creating 2D CDT vertices for facade surfaces in accordance with embodiments of the present invention;

FIG. 12 is an illustrative flowchart of methods for generating colorized 3D models of building facades in accordance with embodiments of the present invention;

FIG. 13 is an illustrative representation of spikes near facade edges in accordance with embodiments of the present invention;

FIG. 14 is an illustrative representation of two different 2D mesh models having different grid point spacing in accordance with embodiments of the present invention;

FIG. 15 is an illustrative representation of a recessed area in a mesh model of a building in accordance with embodiments of the present invention.

FIG. 16 is an illustrative representation of a mesh model of a facade having stretched-out triangles along one of its edges in accordance with embodiments of the present invention; and

FIG. 17 is an illustrative representation of a colored 3D mesh model of a facade in accordance with embodiments of the present invention.

### DETAILED DESCRIPTION

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

As will be appreciated by one skilled in the art, the present invention may be a system, a method, and/or a computer program product. The computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing.

A computer readable storage medium, as used herein, is not to be construed as being transitory signals/per se/, such as radio waves or other freely propagating electromagnetic waves, electromagnetic waves propagating through a waveguide or other transmission media (e.g., light pulses passing through a fiber-optic cable), or electrical signals transmitted through a wire. Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks. The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

In still other instances, specific numeric references such as “first material,” may be made. However, the specific numeric reference should not be interpreted as a literal sequential order but rather interpreted that the “first material” is different than a “second material.” Thus, the specific details set forth are merely exemplary. The specific details may be varied from and still be contemplated to be within the spirit and scope of the present disclosure. The term “coupled” is defined as meaning connected either directly to the component or indirectly to the component through another component. Further, as used herein, the terms “about,” “approximately,” or “substantially” for any numerical values or ranges indicate a suitable dimensional tolerance that allows the part or collection of components to function for its intended purpose as described herein.

Methods disclosed herein generate 3D mesh models of facades. The 3D structure of each 3D mesh model is derived from both (1) edges from a wireframe model of the facade or of the building containing it and (2) a point cloud slice for the facade. The 3D mesh model is somewhat like a hybrid between the sparse but structured wireframe model and the dense but unstructured point cloud. Like the unstructured point cloud, the 3D mesh model captures the subtle curvature, depth variations, and other details of the facade surface, but like the structured wireframe model, the 3D mesh model is also designed to be used in a computer-aided design (CAD) application to quickly perform measurements or analysis of different parts of the facade. The 3D mesh model can be colored to match the original point cloud slice, making it easier to measure the distances between different visual landmarks on the facade. Alternatively, different areas of the 3D mesh model can be colored according to their distance from the facade plane (their “depths”), making it easier to visualize the facade's subtle curvature and unevenness.

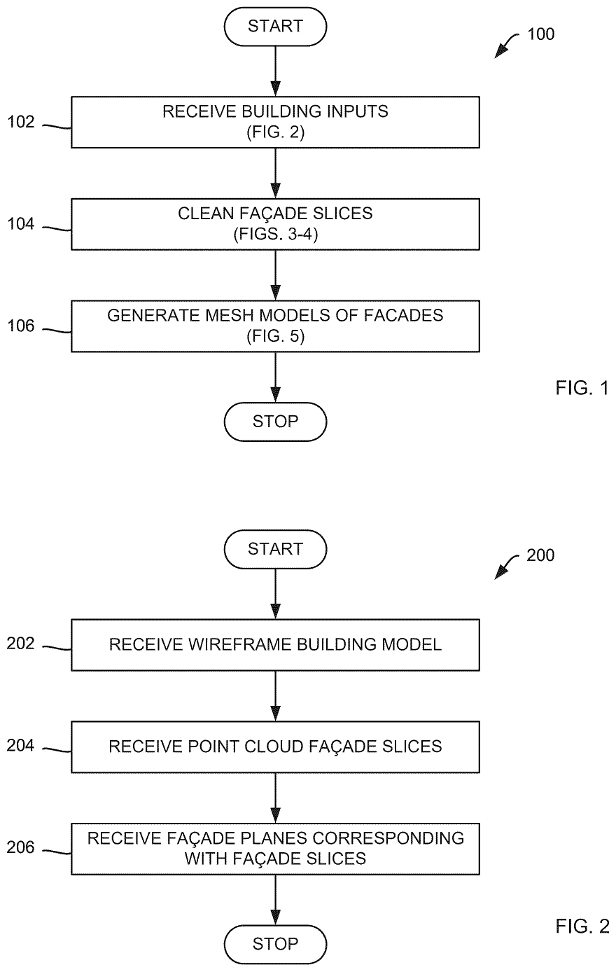

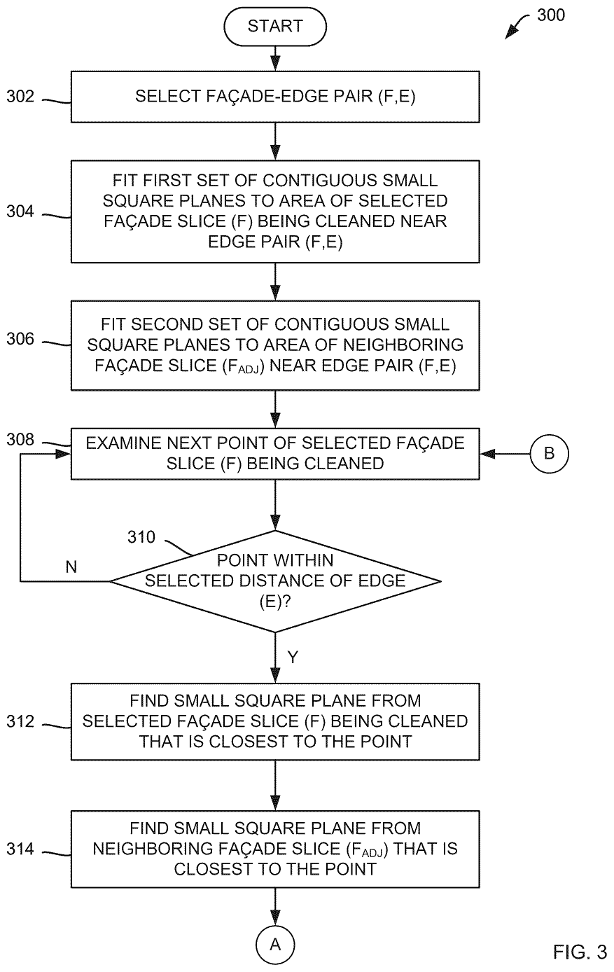

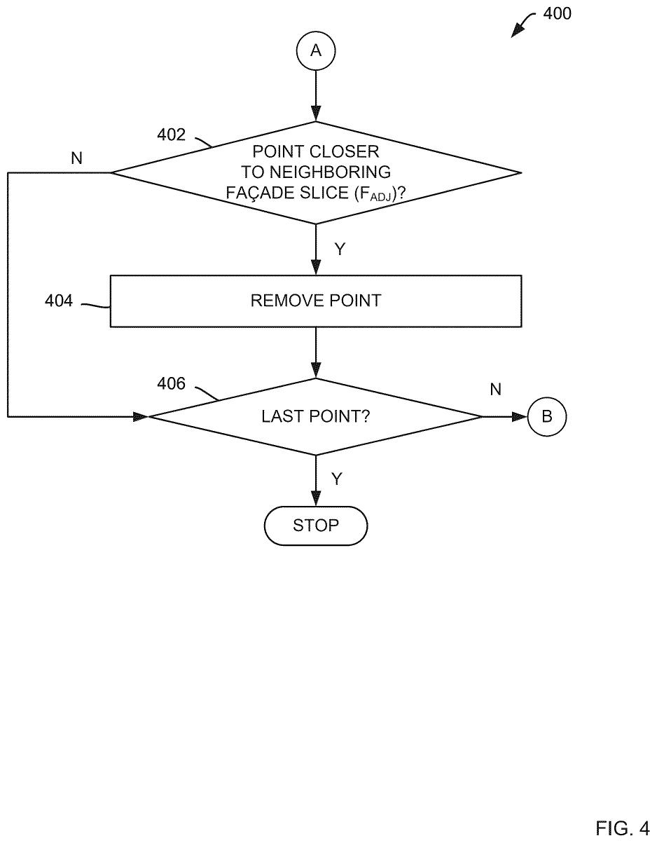

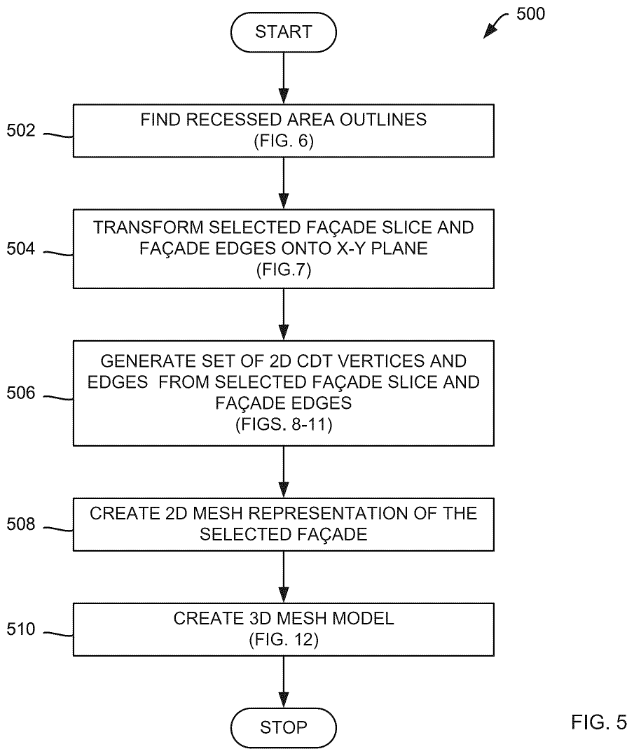

FIG. 1 is an illustrative flowchart 100 of methods for generating mesh models of building facades in accordance with embodiments of the present invention. In particular, flowchart 100 represents an overview of the methods disclosed herein. As such, at a first step 102, the method receives a plurality of building inputs; This step will be discussed in further detail below for FIG. 2. At a next step 104, the method cleans facade slices that correspond with the building inputs; This step will be discussed in further detail below for FIGS. 3-4. At a step 106, the method generates mesh models of building facades; this step will be discussed in further detail below for FIG. 5. As utilized herein, the term mesh model and 3D mesh model are utilized interchangeably.

FIG. 2 is an illustrative flowchart 200 of methods for receiving building inputs in accordance with embodiments of the present invention. At a step 202, the method receives a wireframe building model of a particular building. Wireframe building models may be generated by utilizing any conventional technique without limitation and without departing from embodiments disclosed herein. Wireframe building models may account for the non-idealities of older buildings and include at least facade edges, door outlines, and window outlines. At a step 204, the method receives facade slices that correspond with a building point cloud. That is, for each of the facades of a building, a segmentation process segments out those points from the point cloud that belong to that facade, such that a point cloud “slice” is created for each facade. At a step 206, the method receives planes that correspond with and are fit to the facade slices. In operation, for this step, the method can utilize an algorithm like random sample consensus (RANSAC) to fit planes to each of the facade slices, generating simplified planar representations of each of the facades, or “facade planes.”

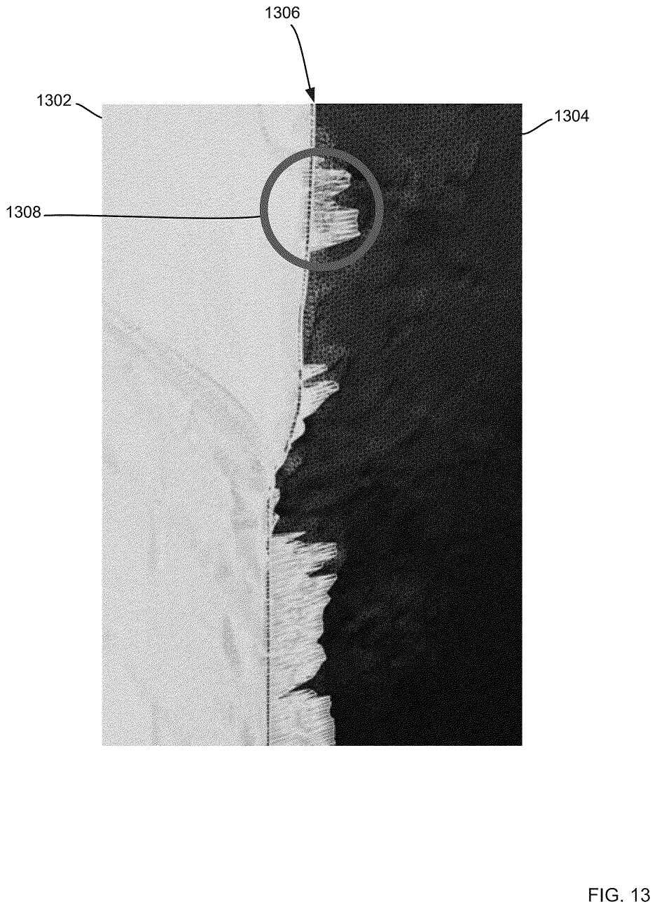

FIG. 3 is an illustrative flowchart 300 of methods for cleaning areas of facade slices near facade edges in accordance with embodiments of the present invention. Sometimes, mesh facade models generated utilizing methods disclosed herein will feature pronounced “spikes” near edges where two facades meet, as shown in FIG. 13, which is an illustrative representation of spikes near facade edges 1308 in accordance with embodiments of the present invention. Spikes 1308 are found along shared edge 1306 between facades 1302 and 1304. Spikes like these result from extraneous points—either noise introduced during the laser scan of the building or points that belong to neighboring facades—being included in the point cloud slice for a facade. For various reasons, facade slices are sometimes represented as 3D rectangular bounding boxes; regardless of the actual shape of a facade, all of the points within the bounding box that corresponds to a given facade are considered part of that facade. Spikes are particularly prevalent in mesh models of facades that are very buckled, warped, or crooked. The less straight a facade is, the larger its bounding box is, and the more nearby points will fall into it and be considered part of the facade. To alleviate this issue, before using facade slices to generate mesh models, methods “clean” the slices before they are used to generate mesh models by detecting and removing extraneous points near edges where two facades meet. The method works on a per-facade, per-edge basis. When a user enables edge cleaning for a facade-edge pair, the method fits two sets of contiguous small square “mini-planes” to the area near the facade edge to approximate the general geometry of the parts of the facades that are closest to the edge. One set of planes is fit to the area near the edge on the facade slice being cleaned, and the other is fit to the area near the edge on the neighboring facade slice. The method then examines all of the points in the facade slice being cleaned that are within a certain distance of the edge, removing those that are closer to the applicable mini-plane for the neighboring facade than they are to the applicable mini-plane for the facade being cleaned. The user can adjust the size and placement of the fitted planes to tailor the cleaning process to the particular facade-edge pair being cleaned.

Turning back to FIG. 3, at a first step 302, the method selects a facade-edge (F, E) pair; an F, E pair includes a selected facade slice (F) and a neighboring facade slice (F_{adj}) that share an edge E (i.e. F_{adj} is the facade that intersects with F at E). Specifically, when a user wants to start the edge area cleaning process for a specific facade F, a mesh model of F is shown in a 3D view alongside the edges that F shares with neighboring facades. When the user selects a facade edge E, E may be highlighted in the 3D view, whereupon the user can adjust the cleaning settings for that particular F, E pair. When a mesh model for F is later generated, at a step 304, the method fits a first set of continuous small square planes to an area of the selected facade slice (F) near E, where each plane in the set is fit to a number of points of the building point cloud. Then, at a step 306, the method fits a second set of continuous small square planes to an area of the neighboring facade slice (F_{adj}) near E, where again each plane in the set is fit to a number of points of the building point cloud.

As such, to start the cleaning process for an F, E pair, the method first assembles the sets of points to which the mini-planes will be fit. For both the selected facade slice (F) and, separately, the neighboring facade slice (F_{adj}), the method gathers all of the points that are between dᵢ meters and dᵢ+l_{P} meters away from E, where:
l_{P} is the mini-plane size set by the user and
dᵢ is the mini-plane “inset distance” set by the user.
In some embodiments, l_{P}=1.50 m and dᵢ=0.1 m.

If the edge E is a complex polyline with many vertices, then to find the aforementioned points efficiently, the method generates a simplified, approximate version of E that contains only a subset of E's vertices. The method uses that simplified edge to estimate points'distances to E instead of calculating their actual distances to E. To do this, the method starts at one of E's endpoints, setting that endpoint as the first endpoint of the simplified version of E. The method then continues along E, stopping at each vertex to check the total length of the polyline segments traveled so far. Once it has traveled l_{S} meters, the method adds the previous vertex—the vertex before the one at which it's currently stopped—to the simplified version of E. The method then continues until it has traveled l_{S} meters from the vertex just added to the simplified version of E, and again adds the previous vertex to the simplified version of E. The method keeps adding vertices every l_{S} meters until it has reached the end of E, at which point the method adds the other endpoint of E to the simplified version. In some embodiments, l_{S}=l_{E}/30, where l_{E} is the total length of E; thus, the simplified version of E will be a polyline with roughly 30 vertices, compared to the hundreds or thousands of vertices that the original version of E may have depending on how it was generated.

Even though facade planes for F and F_{adj} may already be available to the method, the mini-planes that the method fits to the areas near E reflect the particular geometry of their respective sections of F and F_{adj} much more accurately than the facade planes do. Because a facade plane is fit to all of the points in a facade slice, its shape is usually not influenced to a significant degree by the particular geometry of the areas close to the facade's edges. Together, the mini-planes, with their individual variations, much more precisely capture the overall shape of the facades' surfaces, with their subtle curvature and depth variations in different regions. A point's distance to the appropriate one of these mini-planes is a much better approximation of whether it's part of a facade's surface than its distance to the facade plane. The user can control how granularly the mini-planes approximate the facade's surfaces—and, implicitly, how closely points must conform to the particular shape of F's surface in order to not be removed—by adjusting the plane size (l). If l is set too small, however, the mini-planes can be overfit to specific sections of the facade surface, causing points that belong to F to later be erroneously removed from the facade slice, and causing points that belong to F_{adj} not to be removed.

The sets of points used to create the mini-planes don't include the points closest to E; rather, by default, the mini-planes are “inset” several centimeters away from E. Any points belonging to F_{adj} that fall into F's bounding box will by nature be very close to E, which separates the two facades. Because of this, adding the points closest to E to the sets of points used to create the mini-planes can cause, for instance, the mini-planes generated for F to be skewed away from F's surface and towards F_{adj}'s surface. By adjusting the inset distance (d), a user can adjust the degree to which the mini-planes should match the potentially “contaminated” geometry of the areas near E versus the broader overall geometry of the facade.

Once the method has assembled the sets of points that will be used to create the mini-planes, it finds the “major axis” of E—i.e. the axis/coordinate (X, Y, or Z) for which the difference between E's two endpoints is the largest. For example, if E's endpoints were located at (10, 20, 0) and (11, 23, 10), then E's major axis would be the Z-axis. Since facade edges are generally axis-aligned and close to straight, it's usually unambiguous which axis is an edge's major axis. The method then divides the range of major axis values spanned by E's endpoints—e.g., if continuing the example from above, the range from 0 to 10—into “sub-ranges” of length (l) meters. Since l usually does not evenly divide the length of the range of major axis values, the final region is often shorter 1 m. Then, for F and separately for F_{adj}, the method sorts all of the points it previously gathered into groups based on which sub-range they belong to—e.g., if continuing the example from above, each point is assigned to the group that corresponds to which sub-range its Z-coordinate falls into. The method then uses RANSAC to fit a plane to each of the groups of points created for F and for F_{adj}. For this particular use case, RANSAC works by fitting hundreds or thousands of planes to random subsets of the points provided to it as input and returning the plane for which the largest percentage of its source subset is within a certain distance d_{R} of the plane, where d_{R} is the “distance threshold” set by the user. In an embodiment, the threshold is approximately d_{R}=5 cm, so RANSAC prioritizes finding a plane that fits a (non-trivial) subset of points in its input set very closely rather than finding a plane that provides a sufficient overall fit for as many of the points in its input set as possible. The smaller d_{R} is, the less the plane returned by RANSAC will be influenced by points that aren't well aligned with those that make up the facade's surface.

Once the method has finished creating the two sets of mini-planes—one set for F and one set for F_{adj}—it compiles a list of extraneous points that should be removed from F's facade slice before it is used to generate a mesh model of F. At a step 308, the method examines all of the points in F's facade slice, searching for those that are within d_{c} cm of E, using the simplified version of E if necessary to compute the distances; by default, for example, d_{c}=10 cm. If the method determines at a step 310 that an examined point is not within d_{c} cm of E, the point is left in F and the method returns to a step 308. If the method determines at a step 310 that the examined point is within d_{c} cm of E, the method continues to a step 312 to find the small square plane from F that is closest to the point, and then continues to a step 314 to find the small square plane from F_{adj} that is closest to the point.

Continuing to FIG. 4, FIG. 4 is an illustrative flowchart 400 of methods for cleaning areas of facade slices near facade edges in accordance with embodiments of the present invention. In particular, FIG. 4 proceeds from step 314 (see FIG. 3). For each of the points in F's facade slice, the method determines which major-axis sub-range the point falls into, then computes distance from the point to both F's and F_{adj}'s mini-planes for that sub-range. If the method determines at a step 402 that the point is closer to the neighboring facade slice (F_{adj}) than it is to the selected facade slice (F), the method proceeds to a step 404 to remove the point from F's facade slice and add it to a list of extraneous points, whereupon the method continues to a step 406. The extraneous points list may be saved persistently on disk so that it can easily be examined whenever a mesh model of F is generated. If the method determines at a step 402 that the point is not closer to F_{adj} than it is to F, the point is left in F and the method proceeds to a step 406 to determine whether the last point of F has been examined. If the method determines at a step 406 that the last point of F has been examined, the method ends. Otherwise, the method continues to a step 308 (see FIG. 3).

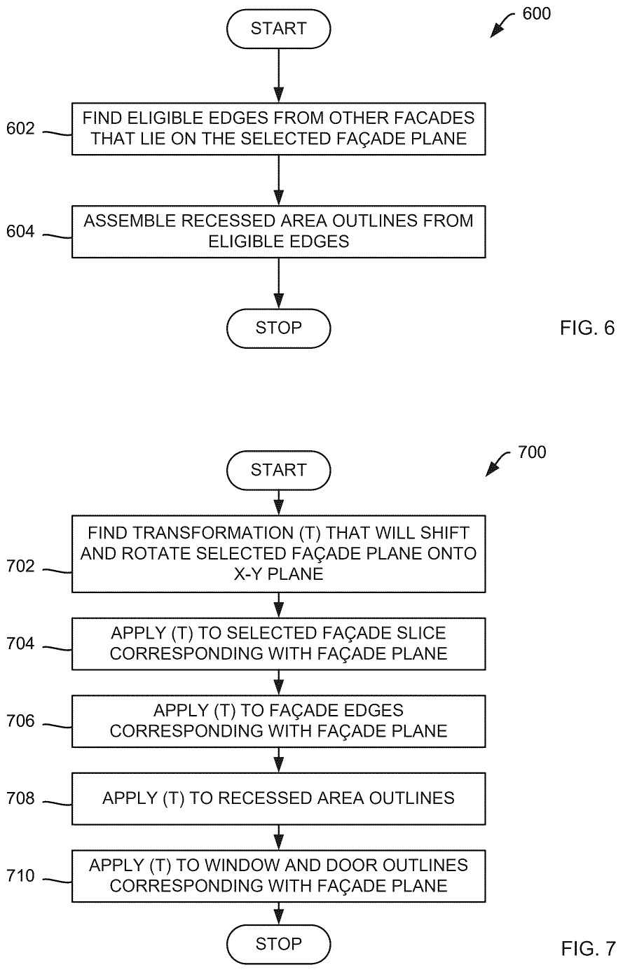

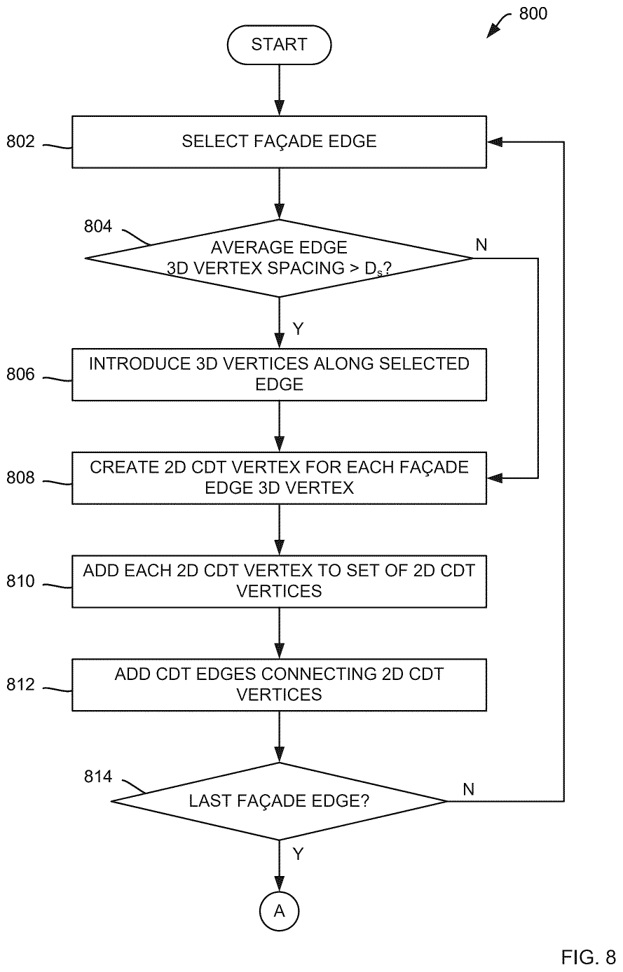

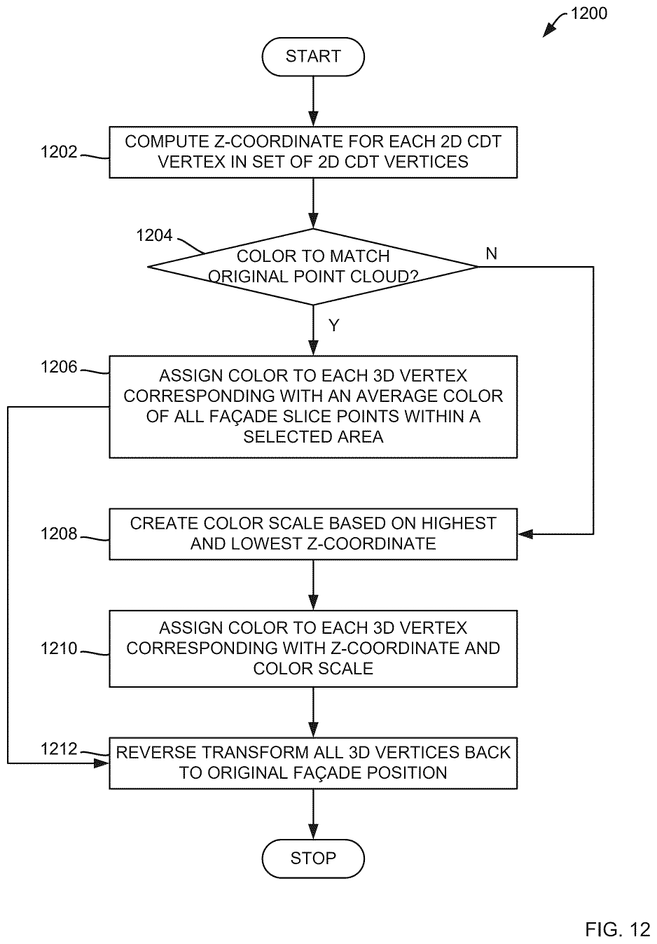

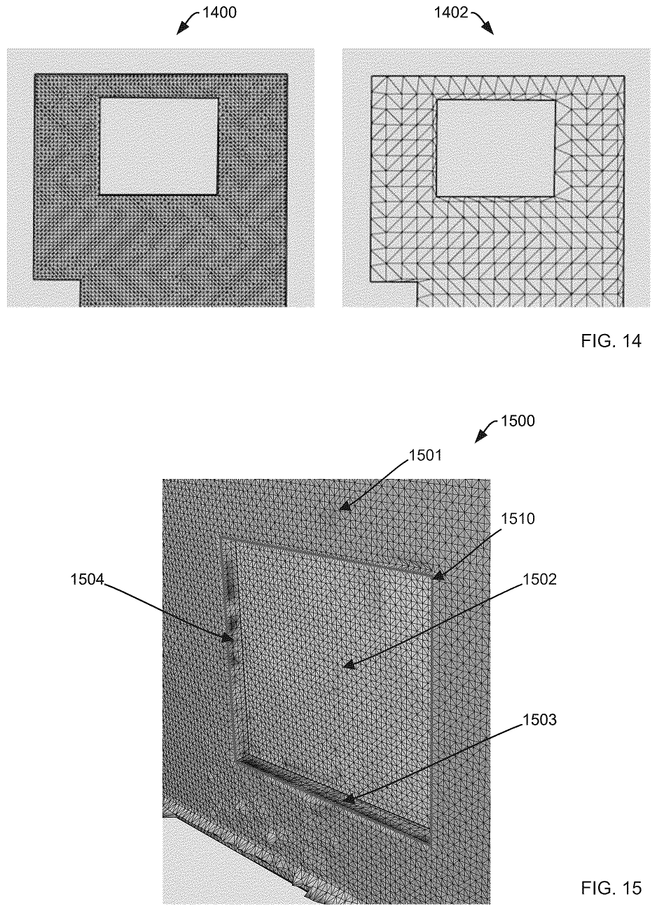

FIG. 5 is an illustrative flowchart 500 of methods for generating mesh models of building facades in accordance with embodiments of the present invention. In particular, FIG. 5 further discloses a step 106 (see FIG. 1). As disclosed herein, methods generate a mesh model of a facade by finding the outlines of any recessed areas in the facade, transforming the facade slice and the facade edges from the wireframe model onto the X-Y plane, generating a set of 2D vertices from the facade slice and facade edges, creating a 2D mesh representation of the facade by generating a constrained Delaunay triangulation of those vertices, and then adjusting the “depths” of each of the triangulation's 2D vertices to reflect the true 3D geometry of the facade surface. As such, at a first step 502, the method finds the outlines of any recessed areas in the facade—i.e. any areas that are “sunken into” the facade and bordered by surfaces perpendicular to the facade. Each recessed area may be represented as an individual facade, separate from the facade into which it is recessed. Each of the perpendicular surfaces bordering a recessed area may also be represented as a separate individual facade. Methods for finding the outlines of recessed areas will be discussed for FIG. 6 below. At a step 504, the method transforms the selected facade slice, the facade edges associated with the selected facade slice, and the window and door outlines associated with the selected facade slice onto an X-Y plane. This operation makes it easy to later create a 2D mesh representation of the facade. Step 504 will be discussed in further detail below for FIG. 7. At a step 506, the method generates an initial set of 2D constrained Delaunay triangulation (CDT) vertices and edges from the selected facade slice and the facade edges that will serve as the borders of the triangulation. Step 506 will be discussed in further detail below for FIGS. 8-11. At a step 508, the method creates a 2D mesh representation of the selected facade. To do this, the method utilizes a CDT library to generate a 2D CDT that contains all of the CDT vertices in the generated initial set of CDT vertices and is bounded by the CDT edges in the generated initial set of CDT edges. In ensuring that the triangulation is bounded by the CDT edges in the set generated by the method, a CDT library automatically removes any CDT vertices that were placed outside of the borders formed by the CDT edges. Any CDT library known in the art may be utilized without limitation and without departing from embodiments disclosed herein. The CDT library's final output—the complete 2D constrained Delaunay triangulation—is represented as a set of CDT vertices and a set of CDT triangles, where each CDT triangle connects together three of the CDT vertices from the set of CDT vertices output by the library. Turning briefly to FIG. 14, FIG. 14 is an illustrative representation of two different 2D mesh models having different grid point spacing in accordance with embodiments of the present invention; 2D mesh model 1400 has a grid point spacing of approximately 5.0 cm and 2D mesh model 1402 has a grid point spacing of approximately 20.0 cm. Returning to FIG. 5, at a step 510, the method creates a 3D mesh model of the selected facade slice by converting each of its 2D CDT vertices into a 3D vertex. Step 510 will be discussed in further detail below for FIG. 12. The method then ends.

FIG. 6 is an illustrative flowchart of methods for finding recessed area outlines in accordance with embodiments of the present invention. In particular, FIG. 6 further clarifies step 502 (see FIG. 5). As noted above, some facades contain recessed areas—i.e. areas that are “sunken into” the facade and bordered by surfaces perpendicular to the facade. Each recessed area may be represented as an individual facade, separate from the facade into which it is recessed. In addition, each of the perpendicular surfaces bordering a recessed area may also be represented as a separate individual facade. When the method generates a mesh model of a facade F, the method creates openings in the mesh around any recessed areas that F contains. Because of those openings, when mesh models of the recessed areas are present in the same model file as a mesh model of F, the recessed areas won't be obscured by the mesh model of F. Turning briefly to FIG. 15, FIG. 15 is an illustrative representation of a recessed area in a mesh model 1500 of a building in accordance with embodiments of the present invention. As illustrated, recessed area 1502 is bordered by surfaces including facade 1503 and facade 1504. Further illustrated is recessed area outline 1510, which may be derived using methods disclosed herein.

Returning to FIG. 6, to determine the outlines of the openings that need to be created in the mesh model of a particular facade (Fᵢ), the method first, at a step 602, examines all of the facades that aren't parallel to Fᵢ and compiles a set (S_{E}) of all of the edges of those facades that lie on Fᵢ. If Fᵢ were facade 1501 (see FIG. 15), S_{E} would include all of the edges that comprise the red outline 1510, including the edges of facades 1503 (see FIGS. 15) and 1504 (see FIG. 15) that lie on facade 1501 (see FIG. 15). An example type of wireframe model input received by the method is the output of a specific type of building modeling software, which consists of two wireframe models of the same building: a “planar model” and a “refined model.” In the planar model, the edges of each facade form a planar polygon—i.e. all of the corners of a given facade lie within the facade plane that was created for that facade. In the refined model, which is intended to be a more precise and detailed representation of the building's edges, the edges of each facade are no longer guaranteed to form a planar polygon, and each edge may be a complex polyline with many vertices. Thus, in the planar model, any facade edges that touch Fᵢ all lie entirely on the facade plane for Fᵢ. For the aforementioned example input type, to find the set of facade edges that lie on Fᵢ, the method examines each of the other facades (Fⱼ) in the planar model. The method first determines whether Fⱼ is roughly parallel to Fᵢ. To do this, the method computes the angle between the normal vector of Fⱼ's facade plane and the normal vector of Fᵢ's facade plane. If the angle between the two facade planes'normal vectors is between 15°and 165°, meaning that Fⱼ and Fᵢ aren't roughly parallel to each other, the method examines each edge (E) of Fⱼ in the planar model. If both of the endpoints of E are within 1 mm of Fᵢ's facade plane, the method finds the edge (E′) in the refined model that corresponds to E and adds E′ to S_{E}. Note that facade planes are not infinite planes but rather finite-extent planes whose boundaries roughly correspond to the boundaries of their corresponding facades; edges whose endpoints are on the same mathematical plane as Fᵢ's facade plane but fall outside the boundaries of Fᵢ's facade plane (i.e. edges that are not fully within the boundaries of Fᵢ) are not added to S_{E}.

At a next step 604, the method assembles the recessed area outlines from the set S_{E} of eligible facade edges that lie on Fᵢ. To do this, the method executes a recursive algorithm similar to depth-first search on S_{E} to find groups of connected edges that form closed shapes. The main building block of this algorithm is the FindShortestPath function embodiment. This function assembles, if possible, a sequence of edges from a provided set of edges that form a continuous path between a specified start point and a specified end point, making sure to use as few edges as possible.

Below is the high-level pseudocode for the FindShortestPath function:

```
function FindShortestPath(StartPoint, EndPoint, Edges) {
  Set ShortestFullPath to [No Path Found]
  For each Edge in Edges that has StartPoint as one of its endpoints: {
    Set RemainderStartPoint to the other endpoint of Edge
    If RemainderStartPoint is the same as EndPoint {
      Return a path consisting only of Edge
    }
    Set RemainingEdges to a set containing all of the edges in Edges except Edge
    Call FindShortestPath(RemainderStartPoint, EndPoint, RemainingEdges) to find the shortest path
    from RemainderStartPoint to EndPoint
    If a path from RemainderStartPoint to EndPoint was found {
      Prepend Edge to the found path to create FullPath, a complete path from StartPoint to EndPoint
      If FullPath is shorter than ShortestFullPath {
        Set ShortestFullPath to FullPath
      }
    }
  }
  Return ShortestFullPath
}
```

To compile the set S_{O} of recessed area outlines, the method scans through all of the points that serve as the endpoint of at least one of the edges in S_{E}. For each such point p, it calls FindShortestPath to find P*, the shortest path composed of edges from S_{E} that both starts and ends at p. If P* exists, the method adds P* to S_{O}. Then, since a given edge can only belong to one recessed area outline, it removes all of the edges that comprise P* from S_{E} before moving on to examine the next point. Sometimes, if the shape of Fᵢ is complex, part or all of the outline of Fᵢ itself can erroneously be detected as a recessed area outline and added to S_{O}. To prevent this from happening, the method ensures that all of the recessed area outlines added to S_{O} contain at least one edge that is not part of the outline of Fᵢ. When the mesh model of Fᵢ is being generated, the method adds CDT vertices and CDT edges for all of the recessed area outlines in S_{O} to the sets of CDT vertices and CDT edges for the model, following the same process used for facade edges and window and door outlines. This makes the recessed area outlines part of the borders of the triangulation, ensuring that the final mesh model won't contain any vertices or edges that fall inside of those outlines and obscure the recessed areas.

FIG. 7 is an illustrative flowchart 700 of methods for transforming facades onto the X-Y plane in accordance with embodiments of the present invention. In particular, FIG. 7 further clarifies a step 504 (see FIG. 5). Transforming a facade onto the X-Y plane makes it easier to later create a 2D representation of that facade. At a step 702, the method finds a transformation (T) that will shift and rotate a selected facade plane onto the X-Y plane. Given the equation that defines an arbitrary plane P, it's relatively simple to derive the 3D transformation that, when applied to P, will place it directly on the X-Y plane. As such, any method known in the art may be utilized to transform the selected facade without departing from embodiments herein and without limitation. Then, at steps 704, 706, 708, and 710, the method applies T to the facade slice, the edges from the wireframe model that belong to the facade, any outlines of recessed areas in the facade, and any outlines of windows and doors on the facade, respectively bringing those objects onto —or, generally, at most a few centimeters straight above —the X-Y plane.

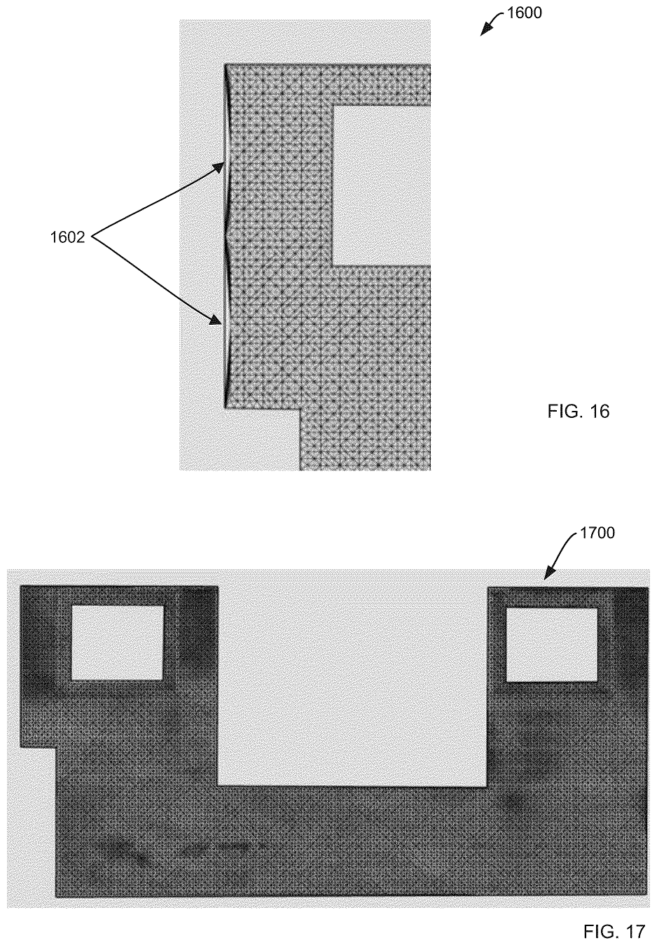

FIG. 8 is an illustrative flowchart 800 of methods for creating 2D CDT vertices for facade edges in accordance with embodiments of the present invention. In particular, FIG. 8 further clarifies a step 506 (see FIG. 5). As noted above, once the facade slice and full wireframe model of the facade are lying roughly on the X-Y plane, at a step 506, the method generates a set of 2D CDT vertices that will be connected to form the constrained Delaunay triangulation, as well as a set of CDT edges (i.e. a set of straight-line connections, each connecting two 2D CDT vertices) that will serve as the borders of the triangulation. First, the method creates the necessary 2D CDT vertices and CDT edges for each of the transformed facade edges that lies roughly on the X-Y plane. The spacing of vertices along each outer border edge of the triangulation needs to at least loosely match the grid point spacing (d) of the mesh model; otherwise, all of the 2D CDT vertices near that border edge will have to be connected to one of the border edge's two endpoints, and distracting stretched-out triangles will occupy the area near the edge, as shown in FIG. 16; FIG. 16 is an illustrative representation of mesh facade model 1600 having stretched-out triangles 1602 along one of its edges in accordance with embodiments of the present invention.

As such, at a first step 802, the method selects a facade edge E. At a step 804, the method determines whether the average spacing between E's vertices is greater than a separation distance (dₛ). If the method determines at a step 804 that the average spacing between E's vertices is not greater than dₛ, the method continues to a step 808. If the method determines at a step 804 that the average vertex spacing is greater than dₛ, the method continues to a step 806 to introduce 3D vertices that are less than dₛ cm apart along E. At a step 806, the method places additional 3D vertices every dₛ cm along the edge, transforming the edge into a “segmentized” polyline. The added vertices are placed directly on the existing facade edge, so the segmentized polyline retains the same exact shape as the original facade edge. At a step 808, the method creates 2D CDT vertices from the X and Y coordinates of each of the 3D vertices along the selected facade edge. At a step 810, the method adds the 2D CDT vertices created for E to the set of 2D CDT vertices for the facade. At a step 812, the method adds CDT edges connecting the 2D CDT vertices for E together, so that a full 2D representation of E will become part of the borders of the triangulation. The method then continues to a step 814, where it determines whether the selected facade edge E is the last facade edge in the set of facade edges associated with the facade. If the method determines at a step 814 that the selected facade edge is not the last facade edge, the method continues to a step 802 to select a facade edge. If the method determines at a step 814 that the selected facade edge is the last facade edge, the method ends.

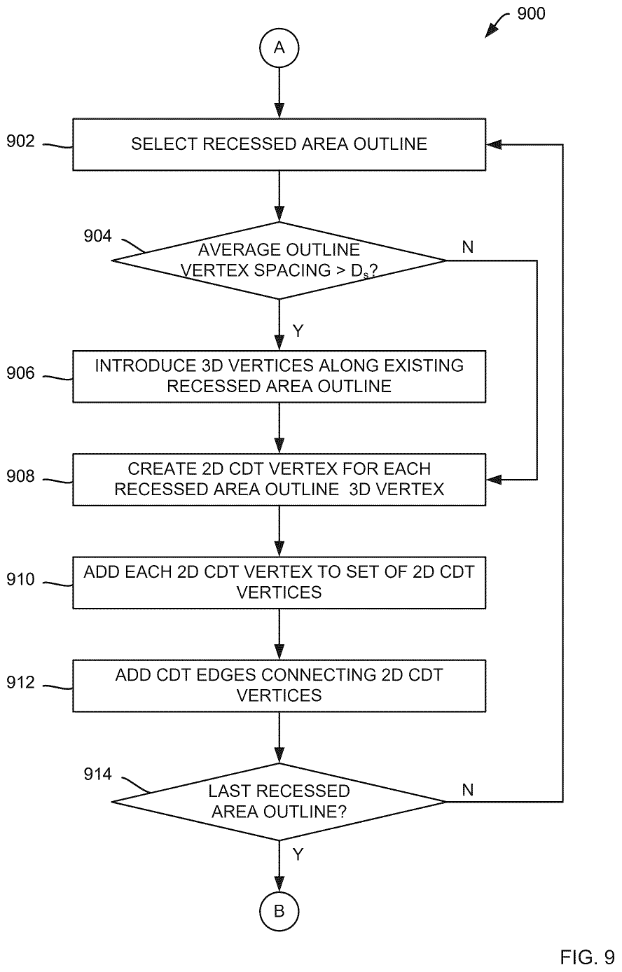

FIG. 9 is an illustrative flowchart 900 of methods for creating 2D CDT vertices for recessed area outlines in accordance with embodiments of the present invention. In particular, FIG. 9 further clarifies a step 506 (see FIG. 5). As noted above, at a step 506, the method generates a set of 2D CDT vertices and edges from the selected facade slice and the recessed area outlines that will form part of the borders of the triangulation. As such, at a first step 902, the method selects a recessed area outline. At a step 904, the method determines whether the average spacing between the outline's vertices is greater than a separation distance (dₛ). If the method determines at a step 904 that the average spacing between the outline's vertices is not greater than dₛ, the method continues to a step 908. If the method determines at a step 904 that the average vertex spacing is greater than dₛ, the method continues to a step 906 to introduce 3D vertices that are less than dₛ cm apart along the selected recessed area outline. Just like for the facade edges discussed above for FIG. 8, at a step 906, the method places additional 3D vertices every dₛ cm along the outline, transforming the outline into a “segmentized” polyline. At a step 908, the method creates 2D CDT vertices from the X and Y coordinates of each of the 3D vertices along the selected recessed area outline. At a step 910, the method adds the 2D CDT vertices created for the outline to the set of 2D CDT vertices for the facade. At a step 912, the method adds CDT edges connecting the 2D CDT vertices for the outline together, so that a full 2D representation of the outline will become part of the borders of the triangulation. The method then continues to a step 914 to determine whether the selected recessed area outline is the last recessed area outline in the set of recessed area outlines associated with the facade. If the method determines at a step 914 that the selected recessed area outline is not the last recessed area outline, the method continues to a step 902 to select a recessed area outline. If the method determines at a step 914 that the selected recessed area outline is the last recessed area outline, the method ends.

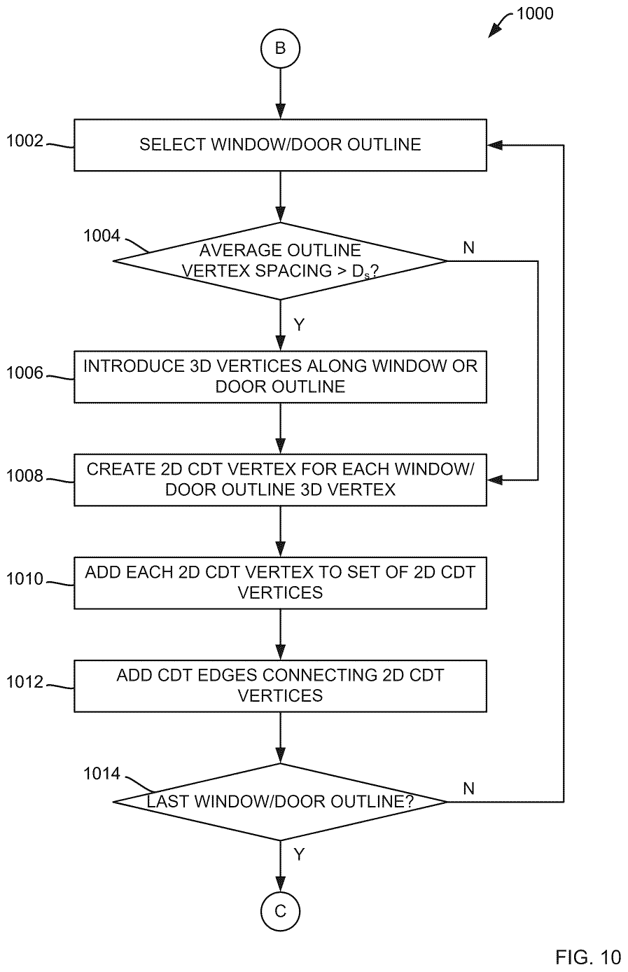

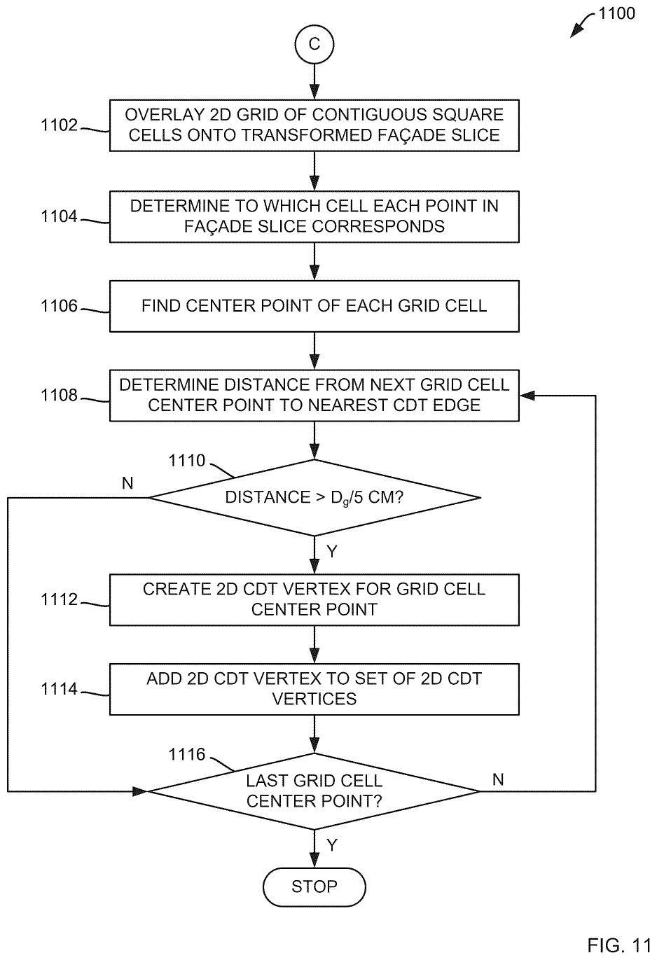

FIG. 10 is an illustrative flowchart 1000 of methods for creating 2D CDT vertices for window/door outlines in accordance with embodiments of the present invention. In particular, FIG. 10 further clarifies a step 506 (see FIG. 5). As noted above, at a step 506, the method generates a set of 2D CDT vertices and edges from the selected facade slice and the window/door outlines that will form part of the borders of the triangulation. As such, at a first step 1002, the method selects a window/door outline. At a step 1004, the method determines whether the average spacing between the outline's vertices is greater than separation distance (dₛ). If the method determines at a step 1004 that the average spacing between the outline's vertices is not greater than dₛ, the method continues to a step 1008. If the method determines at a step 1004 that the average vertex spacing is greater than dₛ, the method continues to a step 1006 to introduce 3D vertices that are less than dₛ cm apart along the selected window/door outline. At a step 1008, the method creates 2D CDT vertices from the X and Y coordinates of each of the 3D vertices along the selected window/door outline. At a step 1010, the method adds the 2D CDT vertices created for the outline to the set of 2D CDT vertices for the facade. At a step 1012, the method adds CDT edges to connect the 2D CDT vertices. The method continues to a step 1014 to determine whether the selected window/door outline is the last window/door outline in the set of window/door outlines associated with the facade. If the method determines at a step 1014 that the selected window/door outline is not the last window/door outline, the method continues to a step 1002 to select a window/door outline. If the method determines at a step 1014 that the selected window/door outline is the last window/door outline, the method continues to a step 1102 (see FIG. 11).

FIG. 11 is an illustrative flowchart 1100 of methods for creating 2D CDT vertices for facade surfaces in accordance with embodiments of the present invention. In particular, FIG. 11 further clarifies a step 506 (see FIG. 5). The method creates a uniform 2D grid of CDT vertices that covers the entire facade surface, with the space between vertices governed by the grid point spacing value specified by the user. As such, at a first step 1102, the method overlays a 2D grid of contiguous square cells measuring d_{g} cm×d_{g} cm each, where d_{g} is the grid point spacing specified by the user, onto the transformed facade slice. At a next step 1104, the method determines which grid cell each point in the selected facade slice falls into based on the point's X and Y coordinates. For each grid cell, the method keeps track of the average Z-coordinate of the points that lie in the cell (i.e. the approximate “depth” of the facade in that specific area). These average point Z-coordinates/depths are utilized later on when the 2D vertices of the triangulation are turned into 3D vertices. Any method known in the art to calculate the average point depths for each cell may be utilized without departing from embodiments disclosed herein and without limitation. At a step 1106, the method finds the center point of each of the cells in the grid. At a step 1108, the method determines how close a next grid cell center point is to the borders of the triangulation (i.e. how close it is to the 2D facade edges, window and door outlines, and recessed area outlines). At a step 1110, the method determines whether the distance from the grid cell center point to the triangulation's borders is within a specified distance (d_{g}/5 cm). If points that are very close to the borders get added to the triangulation as CDT vertices, very small triangles are created near the facade edges and window and door outlines; this clutters the area, making it easy for a user to accidentally select a nearby mesh vertex instead of the actual facade edge or window or door outline, and thus potentially causing them to take an incorrect measurement. If the method determines at a step 1110 that the distance from the grid cell center point to the triangulation′ borders is not greater than d_{g}/5 cm, the method continues to a step 1116. If the method determines at a step 1110 that the distance from the grid cell center point to the triangulation's borders is greater than d_{g}/5 cm, the method continues to a step 1112 to create a 2D CDT vertex from the X and Y coordinates of the grid cell center point. Then, at a step 1114, the method adds the 2D CDT vertices corresponding with the grid cell center points to the set of 2D CDT vertices for the facade. The method continues to a step 1116 to determine whether the selected grid cell center point is the last grid cell center point. If the method determines at a step 1116 that the selected grid cell center point is not the last grid cell center point, the method continues to a step 1108 to select the next grid cell center point. If the method determines at a step 1116 that the selected grid cell center point is the last grid cell center point, the method ends.

FIG. 12 is an illustrative flowchart 1200 of methods for generating colorized 3D models of building facades in accordance with embodiments of the present invention. The method transforms the 2D triangulation into a colorized 3D mesh model by converting each of the 2D CDT vertices in the set of 2D CDT vertices into a 3D vertex and assigning it a color based on the coloring scheme selected by the user. As such, at a first step 1202, the method computes Z-coordinates for each 2D CDT vertex in the set of 2D CDT vertices, to turn the 2D CDT vertices into 3D vertices. As utilized herein, for a vertex, the term “Z-coordinate” refers to an approximate measurement of the “depth” of the facade at that vertex. To compute a Z-coordinate for a given 2D CDT vertex, the method first checks if the 2D CDT vertex is present in the mapping between 2D CDT vertices and 3D vertices that it compiled as it created the initial CDT vertices and CDT edges for the facade edges, recessed area outlines, and window and door outlines. If the 2D CDT vertex is present in the mapping, the Z-coordinate for the 2D CDT vertex is set to the saved Z-coordinate from that mapping. If the 2D CDT vertex is not present in the mapping, the method then checks if the 2D CDT vertex is at least ε=2 cm away from the borders of the triangulation. If the 2D CDT vertex is at least ε=2 cm away from the triangulation's borders, its Z-coordinate is set to the average Z-coordinate of the points in the grid cell (from the aforementioned 2D grid) that it lies in. Otherwise, if the 2D CDT vertex is within ε=2 cm of a border edge, the 2D CDT vertex is “snapped” to the nearest border edge—the X, Y, and Z coordinates of the 2D CDT vertex are set to those of the closest point to the vertex that lies on a transformed facade edge, recessed area outline, or window or door outline. This “snapping” provision was added to the method because, in the process of creating a constrained Delaunay triangulation that conforms to the CDT edges created by the method, the CDT library sometimes introduces additional 2D CDT vertices on or very near the border edges. It's necessary for the same reason that grid cell center points that lie too close to the triangulation's borders aren't added to the initial set of 2D CDT vertices—without the “snapping” provision, very small triangles are created near the facade edges, recessed area outlines, and window and door outlines, making it easy for the user to accidentally select a nearby mesh vertex instead of the actual facade edge, recessed area outline, or window or door outline, and thus potentially causing them to take an incorrect measurement.

If the grid cell that a 2D CDT vertex lies in is “empty”—i.e. no points from the facade slice lie in it, and the average point Z-coordinate of the cell is undefined—the method interpolates an average point Z-coordinate value for the cell using an algorithm very similar to breadth-first search. The method searches for nearby non-empty cells by working outwards from the empty cell, expanding its search scope one “layer” at a time until it finds the N closest non-empty cells; by default, N=50. As the method conducts a search, it maintains several running lists:
SeenCells: a list of all of the grid cells that the method has examined so far
NonEmptyCells: a list of the non-empty grid cells that the method has examined so far
CurrentLayerCells: a list of the cells in the current “layer” being examined
NextLayerCells: a list of the cells in the next “layer” to be examined

The method starts by populating CurrentLayerCells with the empty cell's “neighbors”—i.e. all of the grid cells that are immediately adjacent to the empty cell. The method then adds all of the neighbor cells in CurrentLayerCells to SeenCells. Next, the method examines each cell (C) in CurrentLayerCells. If C is non-empty, the method adds C to NonEmptyCells. Next, regardless of whether or not C is empty, the method adds all of C's immediate neighbors that aren't already in SeenCells to NextLayerCells. Importantly, the method uses SeenCells to keep track of which cells it's already examined and only adds cells to NextLayerCells if they haven't been examined yet; if it doesn't do so, because the neighbors of C include some of the cells in the current layer being examined, the method may get stuck in a loop, examining the same cells over and over again. Once the method has finished processing all of the cells in CurrentLayerCells in this manner, the method checks whether there are at least N non-empty cells in NonEmptyCells. If so, the Z-coordinate of the original empty cell is set to the mean of the average point Z-coordinates for all of the cells in NonEmptyCells. Otherwise, the method sets CurrentLayerCells equal to NextLayerCells, resets NextLayerCells to an empty list, and starts processing the cells in the next layer. The method continues working outwards, examining more and more layers until there are at least N non-empty cells in NonEmptyCells.

As such, at a step 1204, the method determines whether to color the 3D mesh model to match the original point cloud. If the method determines at a step 1204 to color the 3D mesh model to match the original point cloud, the method continues to a step 1206 to assign colors to each of the 3D vertices corresponding with an average color of all facade slice points within a selected area. The method sets the color of each 3D vertex to the average color of all of the facade slice points in the d_{g} cm×d_{g} cm square area around the 2D CDT vertex from which the 3D vertex was created, where d_{g} is the grid point spacing specified by the user. The color of each point in the facade slice is represented as an RGB triplet—a set of three integers, each between 0 and 255, representing how much red, green, and blue, respectively, are mixed to create the color. For each 2D CDT vertex, the method determines the total number of points that lie in the d_{g} cm×d_{g} cm square area around the vertex and the sums of the red, green, and blue values of the colors of all of those points. Specifically, for each individual point (p) in the facade slice, the method scans through the entire set of 2D CDT vertices; for each 2D CDT vertex (v), the method determines whether p lies in the d_{g} cm×d_{g} cm square centered at p. If p does lie in that square, the method increments the total point count for v and adds the red, green, and blue values of p's color to the red, green, and blue value sums for v. Once the method finishes examining all of the points in the facade slice, the method sets the color of each 2D CDT vertex v to the RGB triplet formed by dividing the red, green, and blue value sums for v by the total point count for v. These vertex colors allow the user to easily measure the distances between different visual landmarks on the facades. The method then continues to a step 1212. If the method determines at a step 1202 not to color the 3D mesh model to match the original point cloud, the method continues to a step 1208 to create a color scale based on a highest and a lowest Z-coordinate. The method utilizes the aforementioned Z-coordinate range to create a color scale for the facade using a color scheme. Any color scheme known in the art may be utilized without limitation and without departing from embodiments disclosed herein. At a step 1210, the method assigns a color to each 3D vertex corresponding with the vertex's Z-coordinate and the color scale. These vertex colors give the final model a heat map-like coloration that lets the user easily visualize the facade's subtle curvature and unevenness, as shown in FIG. 17, which is an illustrative representation of a colored 3D mesh facade model 1700 in accordance with embodiments of the present invention.

Returning to FIG. 12, at a step 1212, the method reverse transforms all of the 3D vertices back to true positions corresponding with the building facade. To do this, the method computes T⁻¹, the inverse of the transformation T (see FIG. 7) that was used above to transform the facade onto the X-Y plane; T⁻¹ will shift and rotate the facade away from the X-Y plane and back to its true position. The method applies T⁻¹ to all of the 3D vertices that it created from the 2D CDT vertices output by the 2D CDT library. The method then writes the entire 3D mesh facade model to an OBJ file that can be opened in a CAD application. Since the mesh facade model is represented as a set of vertices—each with a color—and a set of triangles connecting those vertices, and an OBJ file consists of a plain-text list of vertices—optionally with colors—followed by a list of mesh “faces” connecting those vertices, this process is straightforward and mechanical. The method then ends.

The terms “certain embodiments”, “an embodiment”, “embodiment”, “embodiments”, “the embodiment”, “the embodiments”, “one or more embodiments”, “some embodiments”, and “one embodiment” mean one or more (but not all) embodiments unless expressly specified otherwise. The terms “including”, “comprising”, “having” and variations thereof mean “including but not limited to”, unless expressly specified otherwise. The enumerated listing of items does not imply that any or all of the items are mutually exclusive, unless expressly specified otherwise. The terms “a”, “an” and “the” mean “one or more”, unless expressly specified otherwise.

While this invention has been described in terms of several embodiments, there are alterations, permutations, and equivalents, which fall within the scope of this invention. It should also be noted that there are many alternative ways of implementing the methods and apparatuses of the present invention. Furthermore, unless explicitly stated, any method embodiments described herein are not constrained to a particular order or sequence. Further, the Abstract is provided herein for convenience and should not be employed to construe or limit the overall invention, which is expressed in the claims. It is therefore intended that the following appended claims be interpreted as including all such alterations, permutations, and equivalents as fall within the true spirit and scope of the present invention.

What is claimed is:

1. Method for generating a mesh model of a building facade comprising:
receiving a plurality of building inputs;
cleaning a plurality of facade slices corresponding with the building inputs; and
generating the mesh model of the building facade.

2. The method of claim 1, wherein the receiving the plurality of building inputs comprises:
receiving a wireframe building model, the wireframe building model comprising a plurality of facade edges and a plurality of window and door outlines;
receiving the plurality of facade slices corresponding with a building point cloud; and
receiving a plurality of facade planes corresponding with and fit to the plurality of facade slices.

3. The method of claim 2, wherein the cleaning the plurality of facade slices comprises:
selecting a facade-edge pair (F, E) having a shared facade edge, wherein the facade-edge pair includes a selected facade slice (F) and a neighboring facade slice (F_{adj});
fitting a first set of continuous small square planes to a first area of the selected facade slice proximate with the facade-edge pair, wherein the first set of continuous small square planes are each fit to a first plurality of points of the building point cloud;
fitting a second set of continuous small square planes to a second area of the neighboring facade slice proximate with the facade-edge pair, wherein the second set of continuous small square planes each are each fit to a second plurality of points of the building point cloud;
examining each point of the selected facade slice; and
if the examining determines that the point is within a selected distance from the facade edge,
finding the small square plane from the selected facade slice that is closest to the point;
finding the small square plane from the neighboring facade slice that is closest to the point; and
if the point is closer to the small square plane of the neighboring facade slice, removing the point from the selected facade slice.

4. The method of claim 3, further comprising:
if the examining determines that the point is not within the selected distance, leaving the point in the selected facade slice.

5. The method of claim 3, further comprising:
if the point is closer to the small square plane of the selected facade slice, leaving the point in the selected facade slice.

6. The method of claim 3, wherein the generating the mesh model of the building facade comprises:
finding a plurality of recessed area outlines;
transforming the selected facade slice, the plurality of facade edges associated with the selected facade slice, and the plurality of window and door outlines associated with the selected facade slice onto an X-Y plane;
generating a set of 2D vertices from the selected facade slice and the plurality of facade edges;
creating a 2D mesh representation of the selected facade slice; and
creating a 3D mesh model of the selected facade slice.

7. The method of claim 6, wherein finding the plurality of recessed area outlines comprises:
finding a plurality of eligible edges from other facades that lie on the plurality of facade planes; and
assembling the plurality of recessed area outlines from the plurality of eligible edges.

8. The method of claim 6, wherein the transforming the selected facade comprises:
finding a transformation (T) that will shift and rotate a selected facade plane onto the X-Y plane;
applying (T) to the selected facade slice corresponding with the selected facade plane;
applying (T) to the plurality of facade edges corresponding with the selected facade plane; and
applying (T) to the plurality of window and door outlines corresponding with the selected facade plane.

9. The method of claim 6, wherein the generating the set of 2D vertices from the selected facade slice and the corresponding plurality of facade edges comprises:
creating a first plurality of 2D constrained Delaunay triangulation (CDT) vertices along one of the plurality of facade edges;
creating a second plurality of 2D CDT vertices along a plurality of window outlines and a plurality of door outlines; and
creating a third plurality of 2D CDT vertices for a plurality of grid cell center points.

10. The method of claim 9, wherein the creating the first plurality of 2D CDT vertices along one of the plurality of facade edges comprises:
selecting the one of the plurality of facade edges;
introducing 3D vertices along the selected facade edge where a separation distance between existing 3D vertices is greater than a selected separation distance;
creating the first plurality of 2D CDT vertices corresponding with each 3D vertex along the selected facade edge;
adding each of the first plurality of 2D CDT vertices to the set of 2D CDT vertices; and
adding a plurality of CDT edges connecting the first plurality of 2D CDT vertices.

11. The method of claim 10, wherein the creating the second plurality of 2D CDT vertices along the plurality of window outlines and the plurality of door outlines comprises:
selecting the one of the plurality of window outlines or the plurality of door outlines;
introducing 3D vertices along the plurality of window outlines or the plurality of door outlines where the separation distance between existing 3D vertices is greater than a selected separation distance;
creating the second plurality of 2D CDT vertices corresponding with each 3D vertex along the selected window outline or the selected door outline;
adding each of the second plurality of 2D CDT vertices to the set of 2D CDT vertices; and
adding a plurality of CDT edges connecting the second plurality of 2D CDT vertices.

12. The method of claim 11, wherein the creating the third plurality of 2D CDT vertices for the plurality of grid cell center points comprises:
overlaying a 2D grid of contiguous square cells on the selected facade slice;
determining to which cell of 2D grid of contiguous square cells each point in the selected facade slice belongs;
finding the grid cell center point for each cell of the 2D grid of contiguous square cells;
creating a 2D CDT vertex for each grid cell center point where a distance from any of the plurality of facade edges, the plurality of window outlines, or the plurality of door outlines is greater than a selected distance; and
adding the 2D CDT vertices corresponding with the plurality of grid cell center points to the set of 2D CDT vertices.

13. The method of claim 6, wherein the creating the 3D mesh model of the selected facade slice comprises:
computing a Z-coordinate for each 2D CDT vertex in the set of 2D CDT vertices to create a plurality of 3D vertices;
assigning a color to each 3D vertex of the plurality of 3D vertices; and
reverse transforming the plurality of 3D vertices back to a plurality of true positions corresponding with the building facade.

14. The method of claim 13, wherein the assigning a color to each 3D vertex of the plurality of 3D vertices comprises:
assigning the color to each 3D vertex corresponding with an average color of all facade slice points within a selected area.

15. The method of claim 13, wherein the assigning a color to each 3D vertex of the plurality of 3D vertices comprises:
creating a color scale based on a highest and a lowest Z-coordinate; and
assigning the color to each 3D vertex corresponding with the Z-coordinate and the color scale.
